(19) United States
(12) Patent Application Publication
(10) Pub. No.: US 2024/0349642 A1
(43) Pub. Date: Oct. 24, 2024

(54) MULTI-SEGMENTED LAWN MOWER CUTTING BLADE AND LAWN MOWER INCLUDING SAME

(71) Applicant: EXMARK MANUFACTURING COMPANY INCORPORATED, Beatrice, NE (US)

(72) Inventor: Weston Michael Lewis, Lincoln, NE (US)

(21) Appl. No.: 18/629,105

(22) Filed: Apr. 8, 2024

Related U.S. Application Data
(60) Provisional application No. 63/460,463, filed on Apr. 19, 2023.

(51) Int. Cl. A01D 34/73; A01D 34/64; A01D 34/82

(52) U.S. Cl. CPC A01D 34/73; A01D 34/64; A01D 34/826

(57) ABSTRACT

A multi-segmented lawn mower cutting blade and lawn mower including same. The blade may include a hub defining a rotational blade axis and an elongate arm. The arm includes: an origin connected to the hub; a first segment extending outwardly away from the hub in a first direction from the origin to a distal end of the first segment; and a second segment extending from the distal end of the first segment in a second direction, the second direction being different than the first direction. At least a portion of the arm forms a cutting surface configured to cut vegetation as the blade rotates about the blade axis.

This application claims priority to and/or the benefit of U.S. Provisional Patent App. No. 63/460,463, filed 19 Apr. 2023, which is incorporated herein by reference in its entirety.

Embodiments of the present disclosure are directed to lawn mowers and, more specifically, to lawn mower cutting blades for use with the same.

### BACKGROUND

Lawn and garden vehicles are known for performing a variety of tasks. For instance, powered rotary lawn mowers are used by both homeowners and professionals alike to maintain turf areas within a property.

Rotary lawn mowers typically include a cutting deck surrounding one or more cutting blades spinning in a generally horizontal cutting plane. To power the cutting blade, conventional lawn mowers generally utilize either an internal combustion engine or one or more electric motors. The electric motor(s) may receive power from an onboard battery pack that, in addition to powering the cutting blade, may also provide power to a mower propulsion system. Improvements in battery technology have allowed expansion of electric lawn mowers to applications previously perceived as limited to larger gas- and diesel-powered machines.

### SUMMARY

Embodiments described herein may provide a lawn mower cutting blade adapted to reduce noise and energy consumption. An exemplary blade may include a hub defining a rotational blade axis and an elongate arm. The arm includes: an origin connected to the hub; a first segment extending outwardly away from the hub in a first direction from the origin to a distal end of the first segment; and a second segment extending from the distal end of the first segment in a second direction, the second direction being different than the first direction. At least a portion of the arm forms a cutting surface configured to cut vegetation as the blade rotates about the blade axis.

In another embodiment, a toroidal (toroid-shaped) lawn mower cutting blade is provided that includes a hub defining a rotational blade axis and at least two elongate arms. Each arm is supported by the hub and includes an origin and a terminus both located at or near the hub such that each arm forms a closed loop defining a window. At least a portion of each arm forms a cutting surface configured to cut vegetation as the blade rotates about the blade axis.

In still another embodiment, a rotary lawn mower is provided that includes: a cutting deck having an upper surface and one or more sidewalls extending downwardly from the upper surface to define a downwardly opening cutting chamber; a shaft extending through the upper surface of the deck, the shaft defining a shaft axis; and a toroidal lawn mower cutting blade contained withing the cutting chamber. The blade includes: a hub connected to the shaft, the hub defining a rotational blade axis coaxial with the shaft axis; and at least two elongate arms. Each arm is supported by the hub and includes an origin and a terminus both located at or near the hub such that each arm forms a closed loop defining a window. At least a portion of each arm forms a cutting surface configured to cut vegetation as the blade rotates about the blade axis.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 illustrates an exemplary lawn mower configured to utilize a cutting blade in accordance with embodiments of the present disclosure;

FIG. 2 is a bottom perspective view of the mower of FIG. 1 showing a conventional lawn mower cutting blade installed;

FIG. 3 is a perspective view of a multi-segmented lawn mower cutting blade in accordance with embodiments of the present disclosure;

FIG. 4 is a front elevation view of the blade of FIG. 3;

FIG. 5 is a top plan view of the blade of FIG. 3;

FIG. 6 is a side elevation view of the blade of FIG. 3;

FIG. 7 is a perspective view of a multi-segmented lawn mower cutting blade in accordance with another embodiment of the present disclosure;

FIG. 8 is a perspective view of a multi-segmented lawn mower cutting blade in accordance with yet another embodiment of the present disclosure;

FIG. 9 is a front elevation view of the blade of FIG. 8; and

FIG. 10 is a front elevation view of a multi-segmented lawn mower cutting blade in accordance with still another embodiment of the present disclosure.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

Generally speaking, embodiments of the present disclosure may be directed to rotary lawn mower cutting blade configurations adapted to improve power utilization efficiency and reduce blade noise. In some embodiments, the blade may include a hub defining a rotational blade axis, and an elongate arm wherein the arm includes: an origin connected to the hub; a first segment extending outwardly away from the hub in a first direction from the origin to a distal end of the first segment; and a second segment extending from the distal end of the first segment in a second direction, the second direction being different than the first direction. At least a portion of the arm may form a cutting surface configured to cut vegetation as the blade rotates about the blade axis.

In other embodiments, the blade may form a toroidal structure again having a hub for coupling the blade to a powered shaft (blade motor or spindle) to permit rotation of the blade about a blade axis, and an elongate element or arm connected to the hub. For example, the elongate arm may have an origin that is integral with or otherwise coupled to the hub. The elongate arm may extend outwardly from the hub before looping back, such that a terminus of the elongate arm is also positioned at or near the hub (e.g., the hub and elongate element forms a loop). In still other embodiments, the blade may again include a hub and an elongate arm having an origin integral with or otherwise connected to the hub. The elongate arm may extend outwardly away from the hub to a first location, before turning upwardly to form a protrusion at the end of the blade, wherein the terminus of the elongate arm is defined as the unsupported end of the protrusion. In alternative embodiments, the elongate arm may additionally extend radially inward, e.g., from the protrusion toward the blade axis of the hub, such that the terminus is located somewhere between the blade axis and the protrusion.

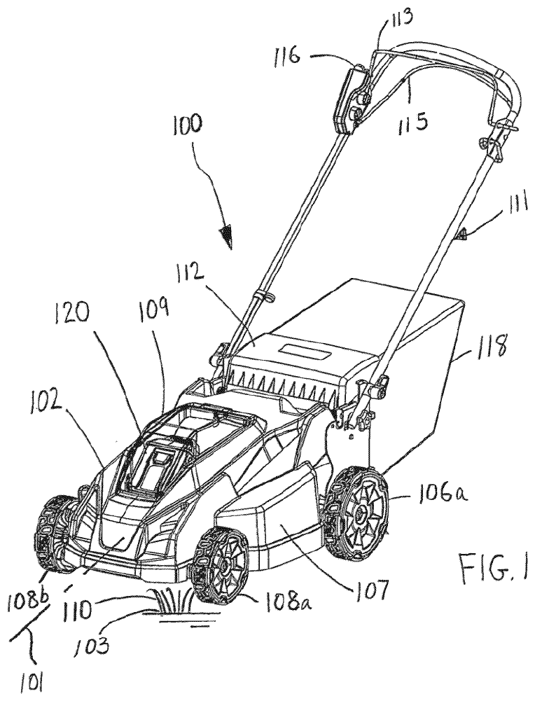

With reference to the figures of the drawing, wherein like reference numerals designate like parts and assemblies throughout the several views, FIG. 1 illustrates an exemplary lawn mower 100 that may utilize a multi-segmented lawn mower cutting blade in accordance with embodiments of the present disclosure. While shown in this view as a self-propelled, walk-behind power mower 100 (also referred to herein simply as a “mower”), such a configuration is not limiting as aspects of the present disclosure may find application to most any type of mower utilizing a rotary-type cutting blade (e.g., single- and multi-blade riding mowers, towed mowers, etc.).

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the mower 100 is in an operating configuration (e.g., while the mower is positioned such that wheels 106 and 108 rest upon a generally horizontal ground surface 103 as shown in FIG. 1). These terms are used only to simplify the description, however, and not to limit the interpretation of any embodiment described. In a similar manner, terms such as “first” and “second” may be used herein to describe various elements. However, such terms are provided merely to simplify identification of the element(s). Accordingly, if an element is described as “first,” there may or may not be subsequent elements—that is, a “second” element is not necessarily present. It is further understood that the description of any particular element as being attached, connected, and/or coupled to another element may indicate that the elements are either directly attached, connected, and/or coupled to one another, or are indirectly attached, coupled, and/or connected to one another via intervening elements.

Still further, the suffixes “a” and “b” may be used throughout this description to denote various left- and right-side parts/features, respectively. However, in most pertinent respects, the parts/features denoted with “a” and “b” suffixes are generally identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature, either individually or collectively.

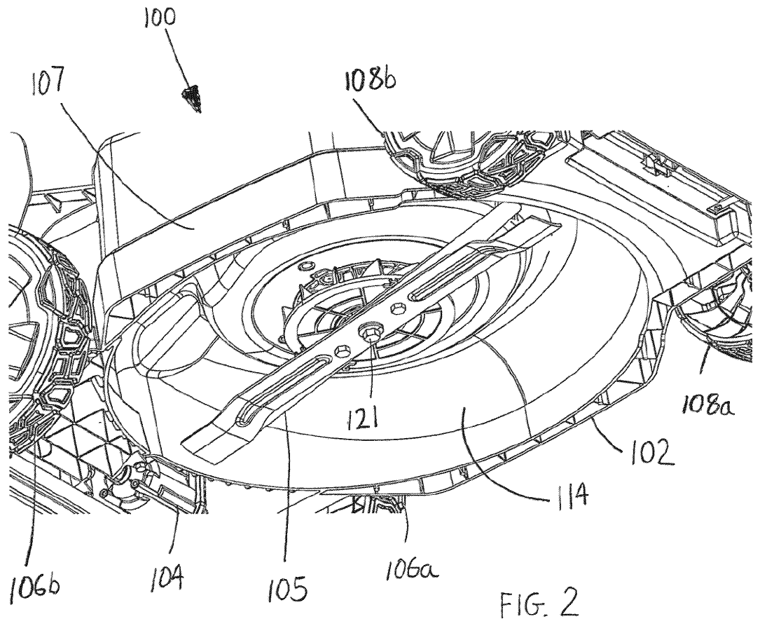

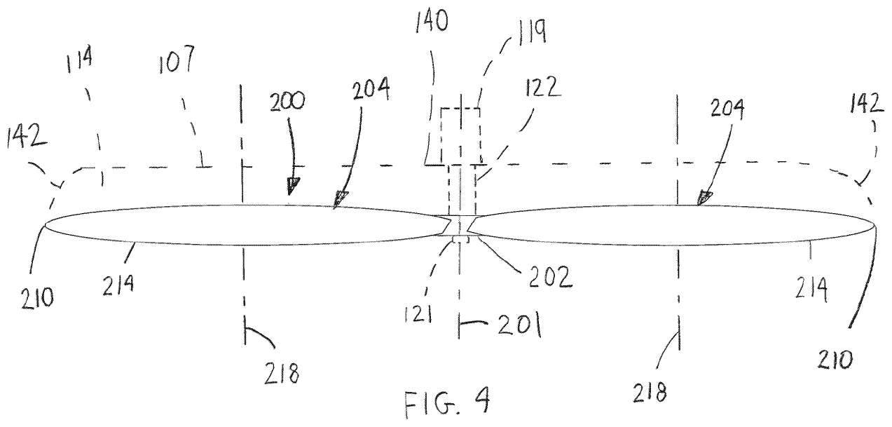

While the general construction of the mower is not necessarily central to an understanding of the present disclosure, an exemplary mower 100 is shown in FIGS. 1-2 and described below. As illustrated in FIG. 1, the mower 100 may include a mower chassis 102 that defines and supports a cutting deck 107 containing at least one rotary cutting blade 105, e.g., the deck 107 may define a cutting chamber 114 in which the rotary cutting blade is positioned. The chassis 102 may further carry one or more prime movers adapted to rotate the cutting blade and/or one or both of the rear wheels 106. While the prime mover(s) may be configured as most any power unit (e.g., an internal combustion engine, an electric motor, etc.), embodiments illustrated herein may utilize a battery-powered electric blade motor 119 (see FIG. 4) to power the cutting blade 105, and a separate electric propulsion motor 104 (see FIG. 2) to power the rear wheels 106 and propel the mower along a travel axis 101 of the mower 100.

The chassis 102 may be supported in rolling engagement upon the ground surface 103 by ground-engaging members that, in one embodiment, include the two rear wheels 106 (left rear wheel 106a, right rear wheel 106b) operatively connected to the mower chassis 102. The rear wheels 106 could be powered either by the blade motor (e.g., via a belt-driven transmission or the equivalent), or as shown in FIG. 2, by the separate electric propulsion motor 104 so that the rear wheels 106 may rotate (relative to the chassis 102) and selectively propel the mower 100 over the ground surface 103. In some embodiments, the propulsion motor 104 may function as a variable speed transmission that selectively rotates at least one of the rear wheels 106 in proportion to an operator-selectable speed control input. As further shown in the figures, a pair of unpowered front ground-engaging members (e.g., left and right front wheels 108a, 108b) may also be included to support a front portion of the mower 100 in rolling engagement with the ground surface 103. Of course, other drive configurations (e.g., front-wheel or all-wheel drive) and other types of ground-engaging members (e.g., tracks, rollers, etc.) located at any suitable position on the chassis 102 (e.g., front, back, sides, etc.), are also contemplated.

To power the various electric motors of the mower 100, one or more battery packs 120 may be carried by the chassis 102. In some embodiments, the battery pack(s) 120 may be effectively permanently attached (e.g., rechargeable while onboard), while in other embodiments, the battery pack(s) may be removably installed on the chassis (e.g., inserted into a receiver of the chassis, e.g., beneath a cover 109 in FIG. 1). In still other embodiments, power may be provided by a cord connected to a remote AC or DC power source. As used herein battery “pack” may refer to a battery unit having one or more individual battery cells contained therein that, in some embodiments, have a lithium-based chemistry (e.g., lithium-ion). Other embodiments may utilize batteries of other chemistries, or other power source technologies (e.g., solar power, fuel cell, etc.) altogether.

As with conventional walk-behind lawn mowers, the mower 100 may also include an upwardly and rearwardly extending operator handle assembly 111 connected to the chassis 102 and having one or more controls located thereon. The controls may permit an operator to control various mower functions from a walking position behind the mower. For example, the controls may include a series of bails 113, 115 that allow actuation and control of the various electric motors. Other controls may include a switch 116 (e.g., to selectively allow the bails to energize the motors) and a speed control (not shown) adapted to vary the speed of the electric propulsion motor. Of course, such controls are exemplary only and mowers lacking such controls (e.g., in the case of autonomous mowers), and/or mowers including controls of a different configuration, are also contemplated.

The mower 100 may optionally include a grass catcher or “bag” 118. The bag 118 may be attached to the chassis 102 such that it fluidly communicates with a discharge channel connected to the cutting chamber 114. The bag 118 may capture and hold grass clippings cut by the mower during operation. In some embodiments, the bag 118 may be removed from the chassis 102 and a mulching plug (not shown) inserted into the channel to block discharge during mulching operation of the mower. A door 112 (see FIG. 1) may also be closed over the channel when the bag 118 is removed. The mower 100 may also include a height-of-cut (HOC) system (not shown) adapted to adjust a height of the cutting deck 107 (and, therefore, a cutting plane or circle defined by the cutting blade 105) relative to the ground surface 103.

FIG. 2 illustrates a conventional rotary lawn mower cutting blade 105 installed on the mower 100. Such blades typically include a central aperture to permit the blade to be attached to a generally vertical shaft of the blade motor (or of a powered spindle shaft of a multi-blade deck) using an attachment bolt 121. While effective, the power required to rotate conventional rotary lawn mower cutting blades may negatively impact the available runtime of the battery packs powering the blade motor. Moreover, while the acoustic signature of such conventional rotary lawn mower cutting blades may be overshadowed by the noise of an internal combustion engine, such blade noise may be more evident to an operator when the blade is powered by a relatively quiet electric motor.

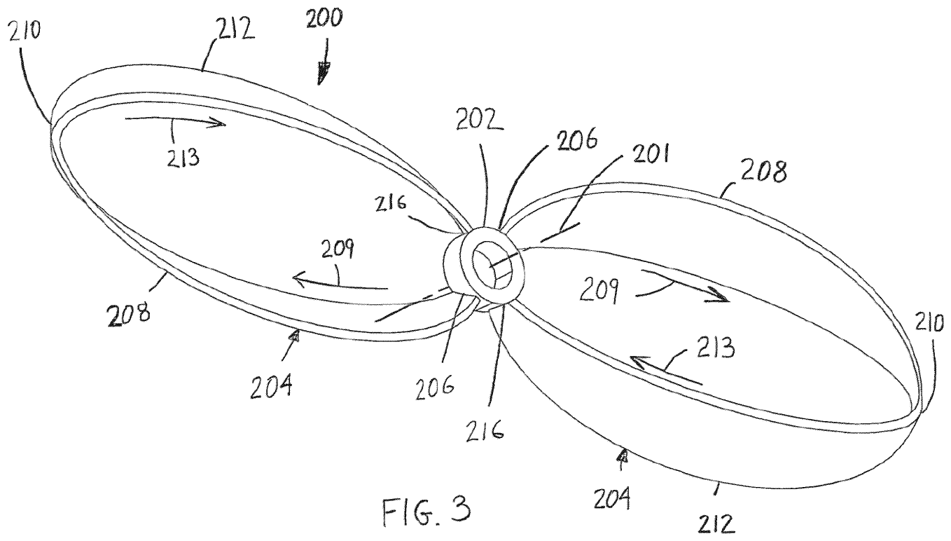

Embodiments of the present disclosure provide blade configurations that seek to alleviate these issues during blade rotation (i.e., reduce one or both of an acoustic signature of the mower blade, and energy required to rotate the mower blade). One such illustrative embodiment is lawn mower cutting blade 200 illustrated in FIGS. 3-6. As shown in these views the blade 200 may include a hub 202 defining a rotational blade axis 201 (see FIG. 4) that is coaxial with (e.g., the same as) a shaft axis of the blade motor/blade spindle. The blade 200 may further include two (e.g., first and second diametrically opposed) elongate arms 204, wherein the second arm extends from a side of the hub opposite the first arm. Each of the arms 204 may include an origin 206 connected or otherwise attached to (e.g., integrally formed with) the hub 202, and a first portion or segment 208 extending outwardly away from the hub in a first direction 209 from the origin 206 to a distal end 210 of the first segment. Each arm 204 may further include a second portion or segment 212 extending from the distal end 210 of the first segment 208 in a second direction 213, the second direction being different than the first direction. At least a portion of each arm 204 may form a cutting surface 214 adapted to cut vegetation 110 (see FIG. 1) as the blade rotates about the blade axis 201. FIG. 4 illustrates the blade 200 as it may be installed within the cutting chamber 114 of the cutting deck 107 (e.g., attached to a shaft 122 of the blade motor 119 (which extends downwardly through the deck) via the bolt 121). The cutting deck may be defined by an upper surface 140 and one or more sidewalls 142 extending downwardly from the upper surface to form the downwardly opening cutting chamber 114 as shown in FIG. 4.

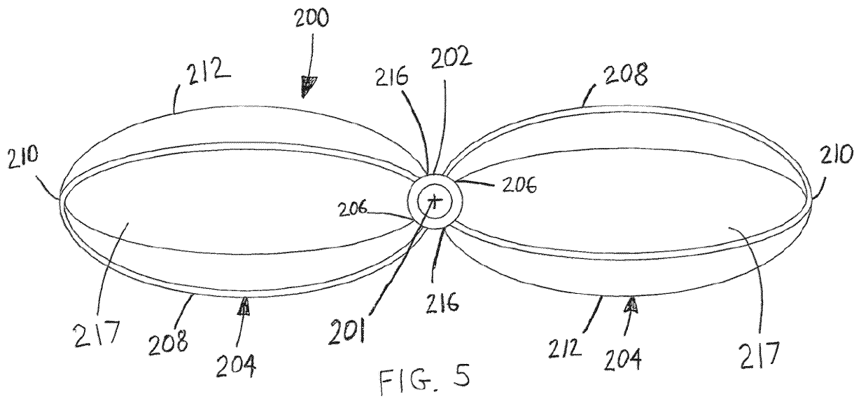

As illustrated in FIGS. 3 and 5, the exemplary blade 200 (e.g., each of the arms 204) may form an annular or toroid shape. That is to say, the second segment 212 may fold, from the distal end 210 of the first segment 208, back towards the blade axis 201, where a terminus 216 of the arm 204 is located at or near, e.g., fixed or otherwise connected to, the hub 202 such that each arm forms a closed loop or ring as shown. In the embodiments illustrated in FIGS. 3-6, each loop may define a generally elliptical shape defining a window 217 having a window axis 218 that is parallel to the blade axis 201 (see FIG. 4). Of course, arms defining loops with window axes that are nonparallel to the blade axis are also contemplated.

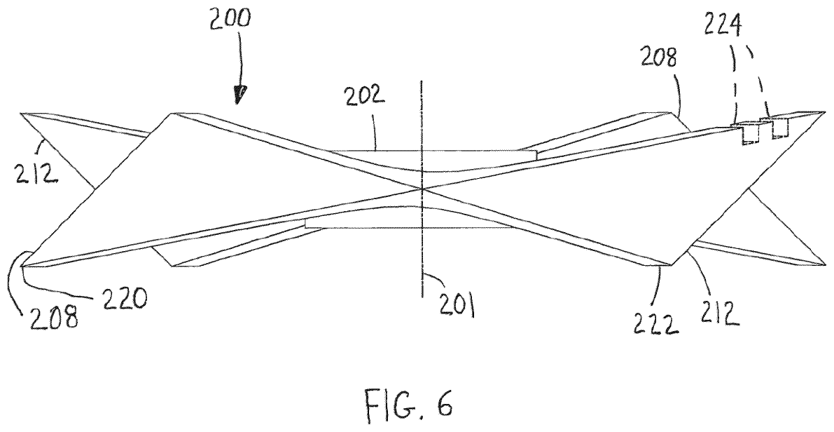

FIG. 6 is an end view of the blade 200, wherein the cutting surfaces of the blade include a first cutting edge 220 on the first segment 208, as well as an optional second cutting edge 222 on the second segment 212. In some embodiments, outermost portions of cutting circle defined by rotation of the cutting blade may define the actual cutting surface(s). While the cutting edges 220, 222 may be positioned at the same elevation, some embodiments may locate the second cutting edge at an elevation higher (or lower) than the first cutting edge. Moreover, the first cutting edge 220 may define a pitch angle (an angle relative to a reference line or plane) that is the same or different than a pitch angle of the second cutting edge 222. The cutting edges (or other surfaces of the blade) may include a cutting or mulching portion defined by one or more notches 224 formed in the arm to effectively shred debris during blade rotation.

While the sound-reducing and energy-conserving benefits of such a blade configuration may vary depending on the specific geometric shape and dimensions of the blade itself, toroidal blades configured in a manner similar to that shown in FIGS. 3-6 could potentially reduce noise that falls within a frequency range of 2-5 kilohertz (kHz).

Other blade configurations are also contemplated, including blades 300, 400, and 500 described below. For consistency, parts/features of the blade 300, 400, and 500 that are similar or identical to like parts/features of the blade 200 may be identified with like series reference numbers. For example, the first segment of the blade may be labeled x08 (wherein “x” is 2, 3, 4, or 5 depending on the embodiment described).

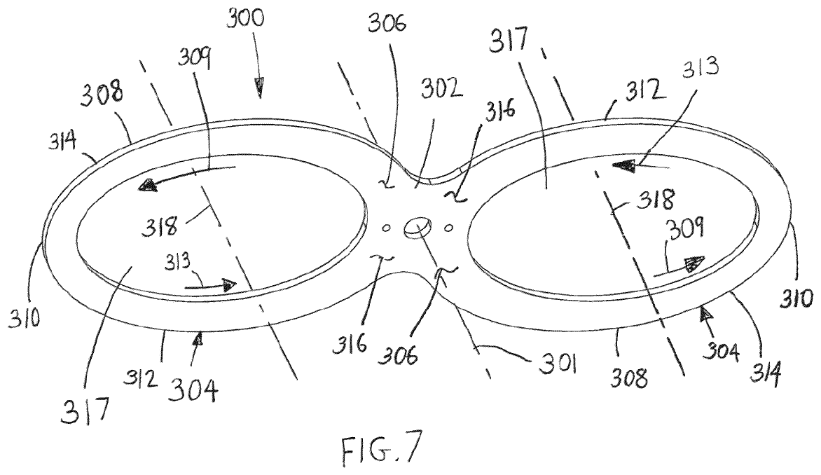

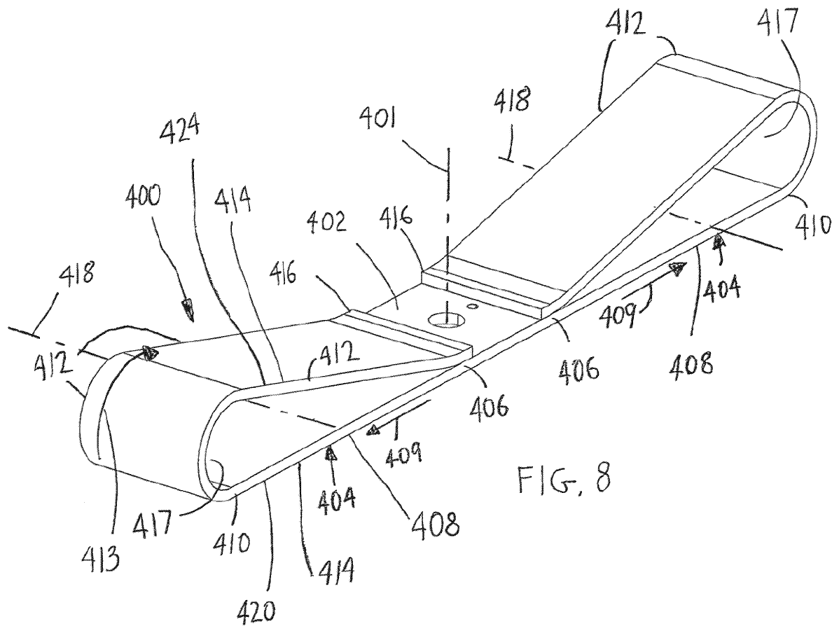

FIG. 7 illustrates a blade 300 in accordance with another illustrative embodiment of the present disclosure. Like the blade 200, the blade 300 may be of a toroidal shape. However, unlike the blade 200, the blade 300 may be configured as a more flattened plate-like structure as shown. Nonetheless, the arms of the blade 300, similar to the blade 200, may define a “FIG. 8” shape when the blade is viewed along its blade axis 301.

The blade 300 may also include a hub 302 defining the rotational blade axis 301, and one or more (e.g., first and second diametrically opposed) elongate arms 304. Each of the arms 304 may include an origin 306 connected or otherwise attached to (e.g., integrally formed with) the hub 302, and a first segment 308 extending outwardly away from the hub in a first direction 309 from the origin 306 to a distal end 310 of the first segment. Each arm 304 may further include a second segment 312 extending from the distal end 310 of the first segment 308 in a second direction 313, the second direction again being different than the first direction. At least a portion of each arm 304 may form a cutting surface 314 configured to cut vegetation as the blade rotates about the blade axis 301.

As with the blade 200, the blade 300 (e.g., the arms 304) may form an annular or toroid shape, e.g., the second segment 312 may extend, from the distal end 310 of the first segment 308, back towards the blade axis 301, where a terminus 316 of the arm 304 is located at or near (e.g., joined integral with or otherwise connected to) the hub 302 such that each arm forms the closed loop or ring as shown. Similarly, each loop may define a generally elliptical shape defining a window 317 having a window axis 318 that is parallel to the blade axis 301.

Due to the generally flat construction of the blade 300, the cutting surfaces 314 (which may define grass cutting edges), may be located on the first segment 308 only, or on both the first and second segments 308, 312. Providing the cutting edges on both sections when both sections are at the same elevation may be useful in certain circumstances, e.g., to assist with mulching, to provide a reversibly-mountable blade, and/or to permit cutting regardless of blade rotational direction about the blade axis 301.

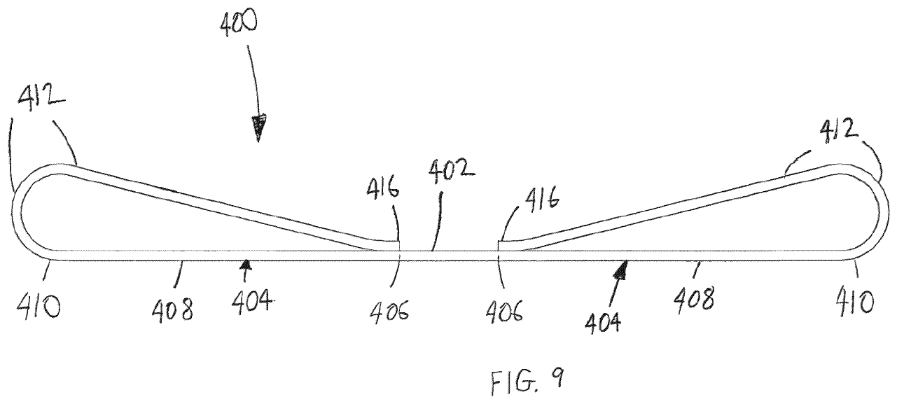

FIGS. 8 and 9 illustrate a blade 400 in accordance with still another embodiment of the present disclosure. Like the blades 200 and 300, the blade 400 may be of a toroidal shape. However, unlike the blades 200 and 300, the loops of each toroid may define a window defining a window axis that is generally orthogonal to a plane containing the blade axis as further described below. Unlike toroidal propellers that are optimized for lift, toroidal cutting blades in accordance with embodiments of the present disclosure are designed and constructed specifically to function within a mixed medium of air and lawn debris. That is, they are configured to transport cut debris within (e.g., mulch)—and effectively discharge the debris from—the cutting chamber. These exemplary toroidal cutting blades thus need to possess sufficient rigidity and mass (and thus moment of inertia) to function effectively in the debris-laden environment common in lawn mowing.

As with the previously-described blades, the blade 400 may include a hub 402 defining a rotational blade axis 401, and one or more (e.g., first and second diametrically opposed) elongate arms 404. Each of the arms 404 may include an origin 406 connected or otherwise attached to (e.g., integrally formed with) the hub 402, and a first segment 408 extending outwardly away from the hub in a first direction 409 from the origin 406 to a distal end 410 of the first segment. Each arm 404 may further include a second segment 412 extending from the distal end 410 of the first segment 408 in a second direction 413, the second direction again being different than the first direction. At least a portion of each arm 404 may form a cutting surface 414 configured to cut vegetation as the blade rotates about the blade axis 401.

As with the blades 200 and 300, the blade 400 (e.g., the arms 404) may form an annular or toroid shape, e.g., the second segment 412 may extend, from the distal end 410 of the first segment 408, back towards the blade axis 401, where a terminus 416 of the arm 404 is located at or near, e.g., connected to or abutting, the hub 402 such that each arm forms a closed loop or ring as shown.

Unlike the prior embodiments, each closed loop of the blade 400 may define a window 417 having a window axis 418 that is generally orthogonal to a vertical plane bisecting the blade lengthwise and containing the blade axis 401. In this particular embodiment, a primary cutting edge 420 may be located on the first segment 408 of each arm, while a secondary cutting edge 424 (e.g., for mulching) may be located on the second segment 412.

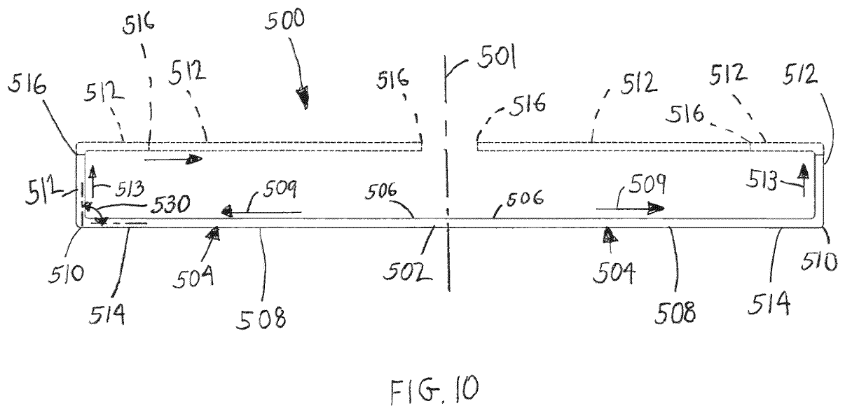

While the blades 200, 300, and 400 are shown as toroidal (e.g., defining enclosed windows), embodiments of the present disclosure that lack such an enclosed structure are also contemplated. For example, FIG. 10 illustrates a multi-segmented lawn mower cutting blade 500 with arms that do not define a fully enclosed window, e.g., the blade 500 may not define a toroidal shape.

The blade 500 may still include a hub 502 defining a rotational blade axis 501, and one or more (e.g., first and second diametrically opposed) elongate arms 504. Each of the arms 504 may include an origin 506 connected or otherwise attached to (e.g., integrally formed with) the hub 502, and a first segment 508 extending outwardly away from the hub in a first direction 509 from the origin 506 to a distal end 510 of the first segment. Each arm 504 may further include a second segment 512 extending from the distal end 510 of the first segment 508 in a second direction 513, the second direction again being different than the first direction (e.g., parallel to the blade axis). At least a portion of each arm 404 may form a cutting surface 514 configured to cut vegetation as the blade rotates about the blade axis 501.

The second segment 512 may extend upwardly from the distal end 510 of the first segment to effectively form a blade protrusion. An axis of the second segment may intersect an axis of the first segment at an angle 530 between 50 and 130 degrees, 60 to 120 degrees, or 70 to 110 degrees, e.g., 90 degrees. While not illustrated, the second segment 512 may also tilt or extend away (e.g., in a direction tangential to a cutting circle defined by rotation of the first segment) from the first segment 508. In other embodiments, the second segment 512 may optionally protrude or extend back toward the axis 501 (e.g., toward the hub 502) as indicated by the broken line portions of the second segment 512 in FIG. 10. That is to say, the second segment 512 may terminate (form a terminus 516) at the unsupported end of the second segment (see solid line representation of terminus 516) or, alternatively, the terminus 516 of each arm 504 may be located at most any radial location between the distal end 510 of the first segment and the blade axis, including at or near the axis 501/hub 502 as shown by the broken line representations of terminus 516.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. A lawn mower cutting blade comprising:
a hub defining a rotational blade axis; and
an elongate arm comprising:
an origin connected to the hub;
a first segment extending outwardly away from the hub in a first direction from the origin to a distal end of the first segment; and
a second segment extending from the distal end of the first segment in a second direction, the second direction being different than the first direction,
wherein at least a portion of the arm forms a cutting surface configured to cut vegetation as the blade rotates about the blade axis.

2. The blade of claim 1, wherein the second direction is parallel to the blade axis.

3. The blade of claim 2, wherein the second segment further extends back toward the blade axis.

4. The blade of claim 1, wherein an end of the second segment defines a terminus of the arm.

5. The blade of claim 4, wherein the terminus of the arm is located at most any radial location between the distal end of the first segment and the blade axis.

6. The blade of claim 4, wherein the terminus of the arm is positioned at or near the hub such that arm forms a toroid.

7. The blade of claim 1, wherein the arm comprises a first arm and a second arm extending from a side of the hub opposite the first arm.

8. A toroidal lawn mower cutting blade comprising:
a hub defining a rotational blade axis; and
at least two elongate arms, each arm supported by the hub and comprising an origin and a terminus both located at or near the hub such that each arm forms a closed loop defining a window, wherein at least a portion of each arm forms a cutting surface configured to cut vegetation as the blade rotates about the blade axis.

9. The blade of claim 8, wherein the window of each arm defines an axis parallel to the blade axis.

10. The blade of claim 8, wherein the window of each arm defines an axis orthogonal to a plane containing the blade axis.

11. The blade of claim 8, wherein each arm comprises a first end defining the origin and a second end defining the terminus, wherein the first end is integrally formed with or otherwise connected to the hub, and wherein the closed loop of each arm is formed by folding the respective arm back such that its terminus is located at or near the hub.

12. The blade of claim 8, wherein the cutting surface of each arm comprises both a first cutting edge associated with a first portion of the closed loop and a second cutting edge associated with a second portion of the closed loop.

13. The blade of claim 12, wherein the second cutting edge is at an elevation higher than the first cutting edge.

14. The blade of claim 12, wherein the first cutting edge defines a pitch angle that is different than a pitch angle of the second cutting edge.

15. The blade of claim 8, wherein the origin and the terminus of each arm are fixed to or otherwise connected to the hub.

16. The blade of claim 8, wherein each of the arms comprises a mulching portion defined by one or more notches formed therein.

17. The blade of claim 8, wherein a shape of the elongate arms is configured to reduce, when the blade rotates about the blade axis, one or both of:
an acoustic signature of the mower blade; and
energy required to rotate the mower blade.

18. A rotary lawn mower comprising:
a cutting deck comprising an upper surface and one or more sidewalls extending downwardly from the upper surface to define a downwardly opening cutting chamber;
a shaft extending through the upper surface of the deck, the shaft defining a shaft axis; and
a toroidal lawn mower cutting blade contained withing the cutting chamber, wherein the blade comprises:
a hub connected to the shaft, the hub defining a rotational blade axis coaxial with the shaft axis; and
at least two elongate arms, each arm supported by the hub and comprising an origin and a terminus both located at or near the hub such that each arm forms a closed loop defining a window, wherein at least a portion of each arm forms a cutting surface configured to cut vegetation as the blade rotates about the blade axis.

19. The mower of claim 18, wherein the cutting surface of each arm comprises both a first cutting edge associated with a first portion of the closed loop and a second cutting edge associated with a second portion of the closed loop.

20. The mower of claim 18, further comprising an electric motor configured to rotate the shaft.
